(19) United States
(12) Patent Application Publication
(10) Pub. No.: US 2005/0246307 A1
(43) Pub. Date: Nov. 3, 2005

(54) Computerized modeling method and a computer program product employing a hybrid Bayesian decision tree for classification

(75) Inventor: Jerzy Bala, Potomac Falls, VA (US)

Correspondence Address: SCHIFF HARDIN LLP;Patent Department, 660 Sears Tower, 233 South Wacker Drive, Chicago, IL, 60606, US

(73) Assignee: Datamat Systems Research, Inc.

(21) Appl. No.: 11/090,364

(22) Filed: Mar. 25, 2005

Related U.S. Application Data
(60) Provisional application No. 60/556,554, filed on Mar. 26, 2004.

(51) Int. Cl. G06N 7/02

(52) U.S. Cl. 706/52

(57) ABSTRACT

In a computerized hybrid modeling method and a computer program product for implementing the method, two classification techniques are integrated: expert elicited Bayesian networks and decision trees induced from data. Bayesian networks are a compact representation for probabilistic models and inference. They have been used successfully for many applications involving classification. The tree-based classifiers, on the other hand, have proven their ability to perform well in real world data under uncertainty. For classification purposes, the inference algorithms to compute the exact posterior probability of a target node, given observed evidence in a Bayesian network, are usually computationally intensive or impossible in a mixed model. In those cases, either the approximate results are computed using stochastic simulation methods or the model is approximated using discretization or Gaussian mixture before applying an exact inference algorithm. For a tree-based classifier, however, once the tree is constructed, the classification process is trivial. The hybrid approach synergistically combines the strengths of the two techniques. Such an approach trades off the accuracy and computation. Significant computational savings can be achieved with a minimum classification accuracy drop.

### CROSS-REFERENCE TO RELATED APPLICATION

The present application claims the benefit of the filing date of provisional application 60/556,554 filed Mar. 26, 2004.

### BACKGROUND OF THE INVENTION

1. Field of the Invention

The invention relates to computerized data modeling and more specifically to the generation of a hybrid classifier to support decision-making under uncertainty.

2. Introduction and Related Art

Uncertainty encountered in predictive modeling for various decision-making domains requires using probability estimates or other methods for dealing with uncertainty. For such modeling the probabilities must be derived using a combination of probabilistic modeling and analysis. Generally in such domains, probability-based systems should capture the analyst's causal understanding of uncertain events and system operational aspects and use this knowledge to construct probabilistic models (in contrast to an expert system, where the knowledge worker attempts to capture the reasoning process that a subject matter expert uses during analysis).

The probability-based systems that are most often used to incorporate uncertainty reasoning are Bayesian networks. A Bayesian network (BN) is a graph-based framework combined with a rigorous probabilistic foundation used to model and reason in the presence of uncertainty. The ability of Bayesian inference to propagate consistently the impact of evidence on the probabilities of uncertain outcomes in the network has led to the rapid emergence of BNs as the method of choice for uncertain reasoning in many civilian and military applications.

In the last two decades, much effort has been focused on the development of efficient probabilistic inference algorithms. These algorithms have for the most part been designed to efficiently compute the posterior probability of a target node or the result of simple arbitrary queries. It is well known that for classification purposes, the algorithms for exact inference are either computationally infeasible for dense networks or impossible for the networks containing mixed (discrete and continuous) variables with nonlinear or non-Gaussian probability distribution. In those cases, one either has to discretize all the continuous variables in order to apply an exact algorithm or rely on approximate algorithms such as stochastic simulation methods mentioned above. However, the simulation methods may take a long time to converge to a reliable answer and are not suitable for real time applications.

In practical situations, Bayesian nets with mixed variables are commonly used for various applications where real-time classification is required, as described in R. Fung and K. C. Chang. Weighting and Integrating Evidence for Stochastic Simulation in Bayesian Networks. Proceedings of the 5th Uncertainty in AI Conference, 1989. Uri N. Lerner. Hybrid Bayesian Networks for Reasoning about Complex Systems. PhD Dissertation, Stanford University, 2002. It is therefore important to develop efficient algorithms to apply in such situations. The trade-offs of some existing inference approaches for mixed Bayesian nets by comparing performance using a mixed linear Gaussian network for testing. The algorithms to be compared include: (1) an exact algorithm (e.g., Junction tree) on the original network, and (2) an approximate algorithm based on stochastic simulation with likelihood weighting [Lerner, 2002] Uri N. Lerner. Hybrid Bayesian Networks for Reasoning about Complex Systems. PhD Dissertation, Stanford University, 2002. Ross D. Shachter and Mark A. Poet. Simulation Approaches to General Probabilistic Inference on Belief Networks. Proceedings of the 5th Uncertainty in AI Conference, 1989 on the original network.

Since, in general, inference is computationally intensive, one approach is to develop a hybrid method by combining the Bayesian net with a decision tree concept. An approach called BNTree R. Kohavi. Scaling up the Accuracy of Naïve-Bayes Classifiers: a Decision-Tree Hybrid, Proceedings of the KDD-96, 1996 was developed which includes a hybrid of a decision-tree classifier and Naïve Bayesian classifier. The structure of the tree is generated as it is in regular decision trees, but the leaves contain local Naïve-Bayesian classifiers. The local Naïve-Bayesian classifiers are used to predict classes of examples that are traced down to the leaf instead of predicting the single labeled class of the leaf.

### SUMMARY OF THE INVENTION

Assuming a mixed Bayesian net is given an object of the present invention, the question is how to develop an efficient algorithm for classification where the direct Bayesian inference is computationally intensive. This object is achieved in accordance with the invention by developing a corresponding decision tree given the target and the feature nodes of the Bayesian net to control the classification process. The decision tree is learned based on the simulated data using forward sampling Max Henrion, Propagation of Uncertainty in Bayesian Networks by Probabilistic Logic Sampling. Proceedings of the 4th Uncertainty in AI Conference, 1988 from the Bayesian network or the real data (if available) by which the Bayesian net was constructed from.
a) In the resulting decision tree, each leaf could either correspond to a strong rule where the data that has fallen into the leaf is highly probable to be from the same class or a weak rule where the decision is less confident. To take the advantage of the efficient process of the decision tree, the inventive method employs a two-step classification process (b and c).
b) Define a criterion to differentiate between a strong and weak rule. With a given evidence data, use the decision tree to make the classification decision when it has fallen onto a strong leaf,
c) Otherwise, use the original Bayesian net to compute the posterior probability of the target node given the evidence, and select the target class with the highest posterior probability.

The above hybrid approach in accordance with the invention can be extended to dynamic Bayesian networks. Two embodiments are multiple tree projection for integration with dynamic Bayesian networks, and incremental tree update for integration with dynamic Bayesian networks

The inventive method, in all forms, is embodied in a computer program product stored on a computer-readable medium that causes the inventive method to be implemented when loaded into a computer.

### DESCRIPTION OF THE DRAWINGS

FIG. 1 schematically illustrates a conventional Bayesian decision tree.

FIG. 2 schematically illustrates an exemplary embodiment of the hybrid approach of a decision tree combined with a static Bayesian network in accordance with the invention.

FIG. 3 schematically illustrates the basic steps of the inventive method wherein the decision tree functions as a data filter.

FIG. 4 schematically illustrates an embodiment of the inventive method employing a multiple tree approach.

FIG. 5 schematically illustrates a further embodiment of the inventive method employing a tree update approach.

FIG. 6 is a graph comparing results obtained with the inventive method to results obtained with conventional method with regard to accuracy.

FIG. 7 is a graph illustrating the computational reduction achieved by the inventive method.

### DESCRIPTION OF THE PREFERRED EMBODIMENTS

Elements of the Hybrid Approach

Bayesian Network

A generic Bayesian net with mixed (discrete-continuous) variables is first considered. Without loss of generality, assuming the goal of inference is to identify the target class with the highest posterior probability of a target node S from K possible states, Sε{s₁, . . . s_{K}}, given a number of evidence/observations E. The a posterior probability of each state sₖ is given by

$$\begin{matrix}P ( S = {s}_{k} \vert E ) = \int p ( S = {s}_{k} , Ω \vert E ) ⅆ Ω \\ = {c}_{k} \int p ( E \vert S = {s}_{k} , Ω ) p ( Ω \vert S = {s}_{k} ) P ( S ) ⅆ Ω ,\end{matrix} \qquad ( 1 )$$

where the coefficient cₖ is a normalization factor, Ω is the set of unknown random variables other than the observable set E that may exist in the network.
Decision Tree

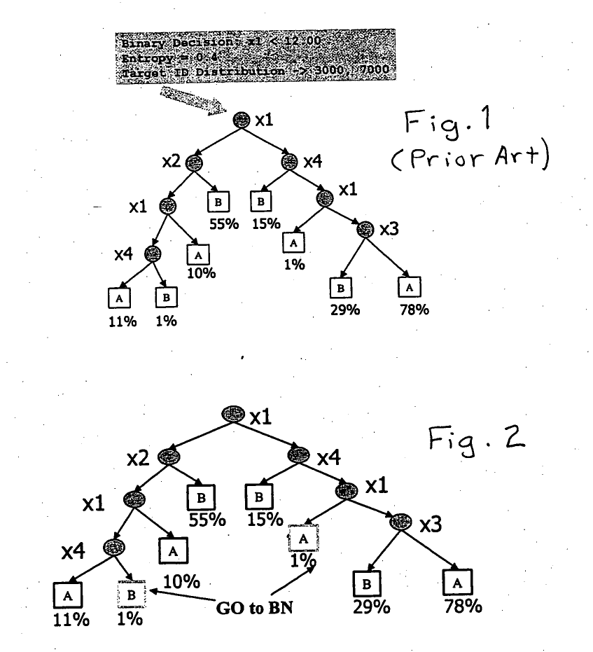

A decision tree (FIG. 1) is a directed graph in the form of a tree. A node describes a single attribute and its decision value. Depending on the relationship of an attribute value to the threshold value, the decision tree is split into child nodes. Child nodes of the next level represent different attributes taken into consideration through the decision making process. The process of tree generation progresses from the root node towards the leaf nodes. A root node represents the most important attribute in the decision process, while a single leaf node contains information about a decision class. The path from the root node to the leaf node constitutes a single decision rule.

The tree learning process employs information theory for the selection of attributes at the decision tree nodes. An entropy measure, described by a mathematical equation (2), is calculated and optimized at every node. It is used to determine the existence of a branch and the selection of node attribute name and its threshold value.

The Hybrid Approach (Decision Tree+Static Bayesian Network)

The hybrid approach according to the invention can synergistically combine the strengths of the two techniques. Such an approach trades off the accuracy and computation. Experimental results conducted by the patent applicants show that a significant computation saving can be achieved with a minimum performance drop.

One main difference of the approach according to the invention is that instead of using a Naïve-Bayesnet as in the aforementioned article by Kohavi, a regular Bayesian net with normal conditional independence assumption is used. The inventor has found, in general, that the performance could be poor when a Naïve-Bayesnet was used.

This hybrid approach builds a decision tree based on the target and the feature nodes of the given Bayesian net. The decision tree is constructed/learned based on the simulated data using forward sampling (See Max Henrion. Propagation of Uncertainty in Bayesian Networks by Probabilistic Logic Sampling. Proceedings of the 4th Uncertainty in AI Conference, 1988) from the Bayesian net or the data (if available) from which the Bayesian net was constructed.

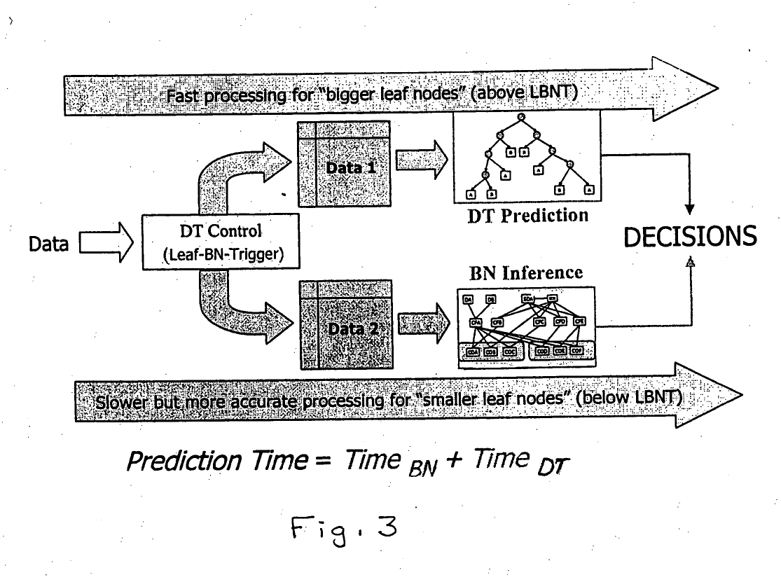

In the resulting decision tree, each leaf could either correspond to a strong rule where the data fallen into the leaf is highly probable to be from the same class or a weak rule where the decision is less confident. For example, a leaf node with 1% or less data from the target with the declared ID (identification) is considered a weak rule (FIG. 2). To take advantage of the efficient process of the decision tree, in accordance with the invention the following classification process is used: With a given evidence data, use the decision tree as a filter. If the data has fallen onto a strong leaf, use the decision to make the classification decision. Otherwise, use the original Bayesian net to compute the posterior probability of the target node given the evidence and select the target class with the highest posterior probability (FIG. 3).

To train the decision tree in accordance with the invention, the random samples are used that are obtained by the forward sampling from the Bayesian net as described earlier. An algorithm such as InferView (J. Bala, S. Baik, B K. Gogia, A. Hadjarian, Inferring and Visualizing Classification Rules. International Symposium on Data Mining and Statistics. University of Augsburg, Germany, Nov. 20-21, 2000) was used to derive the tree structure. To do so, the target node is treated as the classification node and all the evidence nodes are treated as the attribute variables. The resulting tree contained approximately 1,200 leaves.

The basic steps in the inventive computerized method can be summarized as follows:

(1) Generate random samples for evidence nodes given each target state as training data using forward sampling where each sample consists of a six-dimensional vector of real values.

(2) Learn the decision tree from the training data. Each leaf of the resulting decision tree corresponds to a rule for classifying a target ID.

(3) At each leaf, the percentage of data from the declared target ID is calculated. A leaf with this percentage below some threshold value (e.g., below 1%) is labeled as a weak rule.

(4) Generate a different set of random samples of evidence nodes to test the algorithm. Each data sample is first passed through the decision tree. Data fallen into a non-weak rule is declared as the one from the target ID designated by the rule. Otherwise, the data is sent to the Bayesian net for classification decision.

FIG. 3 schematically illustrates these basic steps, wherein the decision tree functions as a data filter.

The hybrid approach described above can be extended to dynamic Bayesian networks. A dynamic BN predicts the future states of the system. Two approaches for hybrid modeling (i.e., combining decision trees with dynamic BNs) are described below.

DTBN Multiple Tree Projection

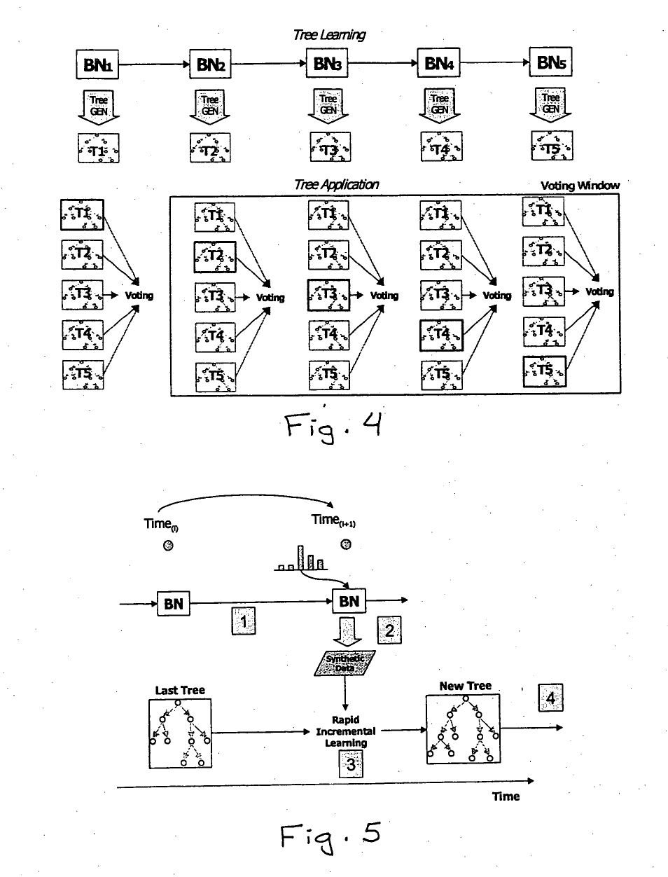

In dynamic states the data points from different states are correlated. The decision trees for the future states learned from synthetic data (similar to that described above) obtained from the dynamic BN for specific time points. Each of these trees is interfaced with a transitioned BN for a specific time point. The method is shown in FIG. 4. Each state has its own tree that is used to do the prediction. The trees are learned from synthetic data sets that are generated from dynamic BN network transitioned to a specific type point (i.e., depicted in Figure as BN1 to BN 5). The final decision is based on the voting results.

There are two kinds of voting for multiple trees; one is uniform voting and the second is called weighted voting and is based on the rule strength. The stronger rule has a higher priority to dominate the decision-making.

DTBN Method with Incremental Tree Update

The dynamic state changes gradually with time, therefore a decision tree learned from an early data set may become obsolete and have no predictive power on the new target information. Consequently, another approach is incremental decision tree learning. This approach requires an online tree to be updated incrementally as needed. It is applied to the data points for which no pre-computed (learned) tree exists. The following steps summarize this approach (schematically illustrated in FIG. 5):
1. BN network is transitioned from time(i) to time(i+1).
2. A small amount of “incremental synthetic data” is generated the transitioned network using an approach similar to the Decision Tree+Bayesian Network Hybrid Approach that was initially described.
3. The decision tree that represents the time point time(i) is rapid updated
4. The new updated tree, DT(i+1) is interfaced with transitioned Bayesian network, BN(i+1), to represents new hybrid classification model, DTBN(i+1). This model is applied to predict decisions

The above-described inventive method is physically implemented in the form of a computer program product embodying the inventive method, in any or all of the above forms, as computer-readable data (software) stored on a suitable medium.

Experimental Results.

First a set of 10,000 random data is generated to train the decision tree. The second set of random data is used to test the algorithm. The results are summarized in Table 1. Table 1 shows that the hybrid approach saves approximately 70% of computation with only about 1.4% reduction in performance. While the decision tree approach is the fastest, it suffers a significant performance loss.

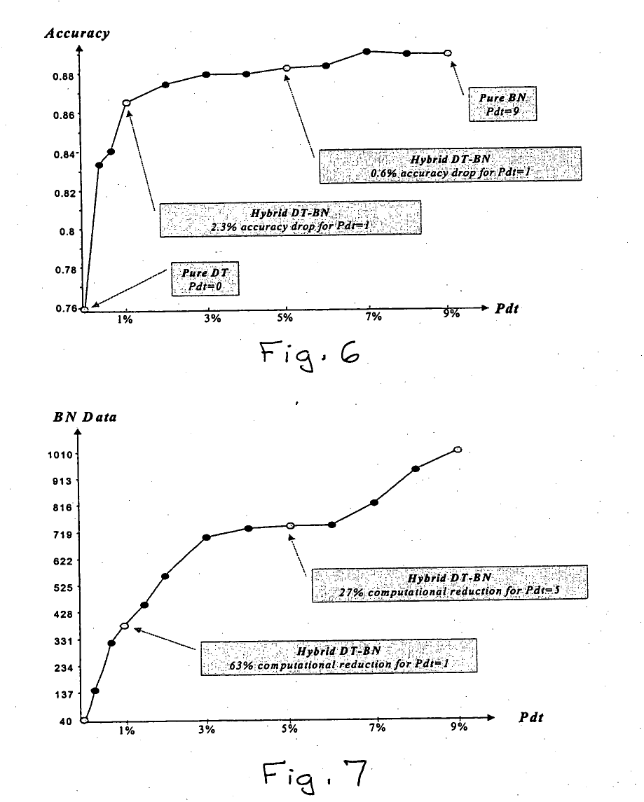

The inventor also has investigated learning rules verses accuracy. FIGS. 6 and 7 depict results obtained for a specific class (i.e., Class 8 for a 10-class classification experiment).

TABLE 1
Average Pcd (Probability of correct detection) and CPU cycles
comparison.

| Approach | DT/BN | PCD | CPU Cycles |
|---|---|---|---|
| BN | 0/100 | 89.35% | 31 * 10¹¹ |
| DT-BN | 70.3/29.7 | 88.13% | 9 * 10¹¹ |
| Hybrid | | | |
| DT | 100/0 | 80.21% | 0.001 * 10¹¹ |

Although modifications and changes may be suggested by those skilled in the art, it is the intention of the inventor to embody within the patent warranted hereon all changes and modifications as reasonably and properly come within the scope of his contribution to the art.

1. A computerized method for classifying data comprising the steps of:
entering an expert-generated, trainable Bayesian network into a computer;
building a decision tree in said computer for classifying incoming data incorporating said Bayesian network, dependent on a classification target for said incoming data; and
classifying said data in said computer according to said decision tree incorporating said Bayesian network.

2. A method as claimed in claim 1 wherein said decision tree comprises a plurality of leaves, and wherein the step of building said decision tree comprises:
building said decision tree in said computer with at least one of said leaves representing a strong rule in said Bayesian network wherein data has a first probability of falling into a class represented by said strong rule, and with at least one other leaf representing a weak rule of said Bayesian network having a probability substantially lower than the probability for said strong rule;
using said decision tree to make a classification decision in said computer for said incoming data if said incoming data falls on said strong leaf; and
if said incoming data does not fall on said strong leaf, using said Bayesian network in said computer to compute a posterior probability for said data falling into a class.

3. A method as claimed in claim 2 comprising employing a probability of less than or equal to 1% for designating said at least one weak leaf.

4. A method as claimed in claim 1 comprising training said decision tree in said computer incorporating said Bayesian network based on simulated data using forward sampling.

5. A method as claimed in claim 1 comprising using a dynamic Bayesian network in said computer as said Bayesian network to build said decision tree.

6. A method as claimed in claim 5 comprising building a plurality of decision trees in said computer respectively representing dynamic states for data points from different states in said dynamic Bayesian network and correlating said dynamic states.

7. A method as claimed in claim 5 comprising building an incrementally updatable tree in said computer and interfacing said updated tree with said dynamic Bayesian network.

8. A computer program product for classifying data comprising a data carrying medium having machine-readable data stored thereon for causing a computer in which said medium is loaded to:
enter an expert-generated, trainable Bayesian net;
build a decision tree for classifying incoming data incorporating said Bayesian network, dependent on a classification target for said incoming data; and
classify said data according to said decision tree incorporating said Bayesian network.

9. A computer program product as claimed in claim 8 wherein said decision tree comprises a plurality of leaves, and wherein said computer program product causes said computer to:
build said decision tree with at least one of said leaves representing a strong rule in said Bayesian network wherein data has a first probability of falling into a class represented by said strong rule, and at least one leaf representing a weak rule of said Bayesian network having a probability substantially lower than the probability for said strong rule;
use said decision tree to make a classification decision for said incoming data if said incoming data falls on said strong leaf; and
if said incoming data does not fall on said strong leaf, use said Bayesian network to compute a posterior probability for said data falling into a class.

10. A computer program product as claimed in claim 9 employing a probability of less than or equal to 1% for designating said at least one weak leaf.

11. A computer program product as claimed in claim 8 allowing training said decision tree incorporating said Bayesian network in said computer based on simulated data using forward sampling.

12. A computer program product as claimed in claim 8 employing a dynamic Bayesian network as said Bayesian network used to build said decision tree.

13. A computer program product as claimed in claim 12 causing said computer to form a plurality of decision trees respectively representing dynamic states for data points from different states in said dynamic Bayesian network and correlating said dynamic states.

14. A computer program product as claimed in claim 12 causing said computer to build an incrementally updatable tree and to interface said updated tree with said dynamic Bayesian network.
